(19) United States
(12) Patent Application Publication
(10) Pub. No.: US 2016/0350534 A1
(43) Pub. Date: Dec. 1, 2016

(54) SYSTEM, APPARATUS AND METHOD FOR CONTROLLING MULTIPLE TRUSTED EXECUTION ENVIRONMENTS IN A SYSTEM

(71) Applicant: Intel Corporation, Santa Clara, CA (US)

(72) Inventors: Rajesh Poornachandran, Portland, OR (US); Ned M. Smith, Beaverton, OR (US); Nitin V. Sarangdhar, Portland, OR (US); Karanvir S. Grewal, Hillsboro, OR (US); Ravi L. Sahita, Beaverton, OR (US); Scott H. Robinson, Portland, OR (US)

(21) Appl. No.: 14/725,310

(22) Filed: May 29, 2015

(51) Int. Cl. G06F 21/57

(52) U.S. Cl. CPC G06F 21/57; G06F 2221/034

(57) ABSTRACT

In an embodiment, a system is adapted to: record at least one measurement of a virtual trusted execution environment in a storage of the system and generate a secret sealed to a state of this measurement; create, using the virtual trusted execution environment, an isolated environment including a secure enclave and an application, the virtual trusted execution environment to protect the isolated environment; receive, in the application, a first measurement quote associated with the virtual trusted execution environment and a second measurement quote associated with the secure enclave; and communicate quote information regarding the first and second measurement quotes to a remote attestation service to enable the remote attestation service to verify the virtual trusted execution environment and the secure enclave, and responsive to the verification the secret is to be provided to the virtual trusted execution environment and the isolated environment. Other embodiments are described and claimed.

### TECHNICAL FIELD

Embodiments relate to security in computer systems.

### BACKGROUND

To improve security of computer systems, some systems can be provided with a trusted execution environment. Such environment can be isolated and thus protected from other code or other entities executing within a system to prevent unauthorized access such as by malware or other known security attacks. Nevertheless, many security concerns can still exist. Further, when multiple isolated environments are available within a platform, they typically do not trust each other and thus certain usage models become complicated.

Another security issue that can arise in systems is that after secure content such as licensed video, music or other content is downloaded to a system, the device becomes rooted. While in a rooted status, unauthorized access to this secure content may undesirably occur in a rooted system, even if the rooted device is prevented from downloading additional secure content.

### BRIEF DESCRIPTION OF THE DRAWINGS

FIG. 1 is a high level block diagram of a computing system in accordance with an embodiment of the present invention.

FIG. 2 is a flow diagram of a high level method for creating multiple trusted environments within a computing system and performing a remote attestation in accordance with one embodiment of the present invention.

FIG. 3 is a flow diagram of a method for preparatory operations to be performed in creating a secure environment as described herein.

FIG. 4 is a flow diagram of a method for performing further preparatory operations in accordance with one embodiment of the present invention.

FIG. 5 is a flow diagram of an example method for performing a mutual authentication between isolated environments in accordance with one embodiment of the present invention.

FIG. 6 is a block diagram of a computer system in accordance with another embodiment of the present invention.

FIG. 7 is a block diagram of another system in accordance with an embodiment.

FIG. 8 is a flow diagram of a method for performing a secure content clear operation during a boot environment of a system.

FIG. 9 is another flow diagram of a method for performing a secure content clear operation during a runtime environment of a system.

FIG. 10 is a flow diagram of a method for performing a secure content clear operation in accordance with another embodiment.

FIG. 11 is a block diagram of an example system with which embodiments can be used.

FIG. 12 is a block diagram of a system in accordance with another embodiment of the present invention.

### DETAILED DESCRIPTION

In various embodiments, multiple secure environments of a computing system, including an enclave-based secure environment and a virtualization-based secure environment, can be authenticated and mutually attested to each other. In this way, after such mutual attestation, isolated environments can share information during system operation, such as secure information for use in user and other authentications. This is the case, as some processors enable a platform to support multiple different trusted execution environment (TEE) technologies. Embodiments may be used to ensure attestation between these technologies.

As will be described in a particular embodiment, one trusted execution environment may be implemented using Intel® Software Guard Extensions (SGX) enclaves and a second TEE may be implemented using a Virtualization Technology (VT) virtual trusted execution environment. These technologies, along with platform infrastructure software can each offer a TEE by isolating memory regions from the rich operating system (OS) and providing access control rules around memory regions, to only allow access to authorized entities.

In another embodiment, an intellectual property (IP) block in a platform chipset or integrated into an uncore of a processor package can communicate between an SGX enclave and a converged security engine (CSE). In addition, attestation between SGX and VT entities may be extended for combinations involving CSE-to-SGX and CSE-to-VT. In such embodiments, the CSE can reserve memory mapped IO regions such that the memory region isolation mechanism that allows access to authorized entities may be employed with a security coprocessor such as a CSE.

Embodiments allow multiple TEEs to provide verifiable evidence that the respective TEE is valid/good and local to the platform. That is, an SGX enclave can prove it is authorized to the VMM and vice versa—and that both reside on the same physical platform. In this way, security solutions can span both TEE technologies and make meaningful attestations to remote parties. One example security solution is the use of VT-based trusted I/O for SGX enclaves, e.g., a You-Are-the-Password (YAP) scenario where VT-enhanced page table (EPT)-protected camera data containing iris scan biometric information is then passed into an SGX enclave for matching against a pre-provisioned template. Such operations performed outside of a processor's standard mode of operation (also referred to as a rich execution environment (REE)) can provide greater security assurances, as a REE is susceptible to malware attacks and hence is not suitable for preserving the privacy of user data such biometrics, as well as being susceptible to replay attacks, such as spoofing a biometric authentication match.

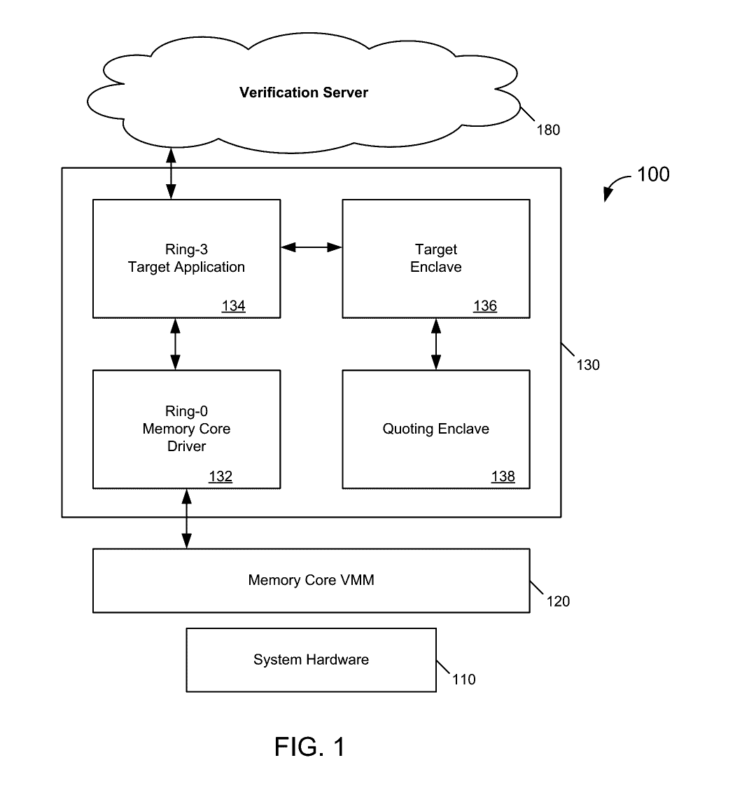

Referring now to FIG. 1, shown is a high level block diagram of a computing system in accordance with an embodiment of the present invention. As shown in FIG. 1, system 100 may be any type of computing platform, ranging from small wearable and/or portable device such as a given wearable device, smartphone, tablet computer or so forth, to a larger system such as a desktop computer, server computer or so forth. As seen, system 100 includes system hardware 110. While many different implementations of such system hardware are possible, in typical cases the hardware includes at least one or more processors, one or more memories and storages, and one or more biometric authentication devices, and one or more communication interfaces, among other components. In a particular implementation, hardware 110 may further include security hardware, which in an embodiment can take the form of a trusted platform module (TPM).

Still with reference to FIG. 1, a virtual trusted execution environment (TEE) 120 may execute on this system hardware. In an embodiment, virtual trusted execution environment 120 may be implemented as a memory core (MemCore) virtual machine monitor (VMM) to provide a virtualization-based TEE.

In turn, an isolated environment 130 may be launched using virtualization trusted execution environment 120. In the embodiment shown in FIG. 1, isolated environment 130 includes a driver 132 which in an embodiment is a ring-0 memory core driver that interfaces with virtualization TEE 120 and further interfaces with a target application 134, which in an embodiment may be a ring-3 application. In turn, application 134 may interface with a target enclave 136, which in an embodiment may be a given secure enclave provided via a protected portion of a memory environment. In turn, target enclave 136 may communicate with a quoting enclave 138. In various embodiments, quoting enclave 138 may be adapted to sign a quote on behalf of target enclave 136, e.g., using an Inter-based enhanced privacy ID (EPID).

As further illustrated in FIG. 1, system 100 may be coupled via a given network such as an Internet-based network, to a verification server 180, which may be implemented as one or more servers of a remote attestation service of a particular entity. In the embodiment shown, target application 134 may control communication with this verification server 180. Understand while shown at this high level in the embodiment of FIG. 1, many variations and alternatives are possible.

In an embodiment a TPM-measured launch of MemCore VMM 120 may be used to establish a valid/good MemCore VMM before untrusted third party code is installed. The name MemCore refers to VMM (and ring-0 agent) software that provides a VT-based TEE. In an embodiment, this MemCore uses extended page table (EPT)-based isolation/protection for regions of memory, called a “memory view,” by defining page tables only including the target data and code authorized to access that target data.

An SGX application (e.g., application 134), which may include untrusted and trusted enclave code, is launched along with a quoting enclave and other SGX-related runtime code. These SGX-related entities can be encapsulated by MemCore in isolated memory region 130 (or regions) so that they cannot communicate with or be subverted by external entities. EPT protections apply to SGX enclave page cache (EPC) memory because address translations for SGX EPC memory are subject to page translations and permission checks.

SGX and TPMs provide certain locality assurances, software measurement, quoting and sealed storage capabilities. A quote providing verifiable evidence about the launched MemCore VMM may originate from the TPM; and a quote about the SGX enclave may originate from its respective quoting mechanism. MemCore isolations of the SGX components prevent man-in-the-middle attacks and are used with the SGX and TPM quote properties to ensure locality on the platform. The TPM quote for MemCore and the SGX quote may be bundled and sent to a remote verifying service. If verified, MemCore and SGX are then mutually authenticated to one another and they establish a shared secret K which can be used on subsequent boots without requiring network access or the verifying service. Once MemCore and this first SGX enclave are mutually authenticated, other SGX enclaves, as needed, can be whitelisted and authenticated to MemCore via SGX local attestation and communications.

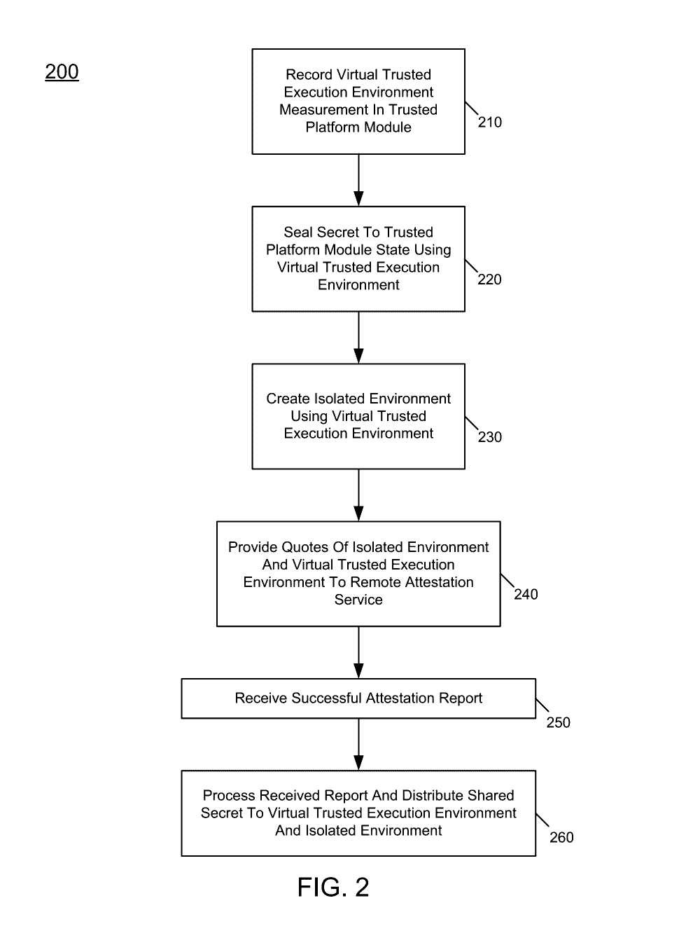

Referring now to FIG. 2, shown is a flow diagram of a high level method for creating multiple trusted environments within a computing system and attesting to the same via a remote attestation service. Understand that in the embodiment shown in FIG. 2, the operations can be performed by many different entities within the system, including various combinations of hardware, software, and/or firmware, including hardware control logic configured to perform operations of one or more portions of the method. As seen, method 200 begins by recording a virtual TEE measurement in a TPM (block 210). This measurement may be of a virtual control entity, such as a VMM, hypervisor or other supervisor control logic to control entry into and exits from virtual machines or other virtualized logic that execute under the virtual trusted execution environment. In an embodiment, this recording may be a measurement of a trusted state of the virtual trusted execution environment and can be stored in a secure storage included in or otherwise associated with a TPM, such as one or more platform configuration registers (PCRs).

Next, control passes to block 220 where a secret may be sealed to this TPM state using the virtual trusted execution environment. In an embodiment, the secret, which may be a cryptographically generated secret value such as a key, credential or other signature, may be stored in an appropriate storage such as a trusted storage associated with the TEE.

Still with reference to FIG. 2, next at block 230 an isolated environment can be created. More specifically, the virtual TEE may create this isolated environment. In an embodiment, this isolated environment may include various logic or other modules. In a representative embodiment, such modules include a ring-3 (i.e., user mode) application, a trusted driver (which in an embodiment may be a ring-0 (i.e., supervisor mode) driver to interface with the virtual TEE), a secure enclave, and a measurement enclave, which may be configured to provide a measurement responsive to a request.

Next at block 240 quotes of the isolated environment and the virtual trusted execution environment can be provided to the remote attestation service. In an embodiment, the application within the isolated environment may request measurement quotes, which it may receive from the secure enclave (which in turn obtains the measurement from the measurement enclave) and the virtual TEE. Note that in different implementations, certain measurement information from these two different measurements may be concatenated in some manner to provide an overall measurement quote to the remote attestation service. In an embodiment, a simple combining of the two measurement quotes may be performed. In other cases, only parts of the two measurement quotes may be extracted and included in the measurement quote, which may be sent as an encrypted blob.

Still with reference to FIG. 2, next at block 250 a successful attestation report may be received from the remote entity. In an embodiment, the application that sent the measurement quote may receive this successful report. In turn, the application can process the received report (block 260), which in an embodiment may include the original secret, which can be sent to the respective entities (namely the isolated environment and the virtual TEE) for secure storage. As such, these separate and isolated entities may perform future mutual authentications or attestations using this shared secret. Understand while shown at this high level in the embodiment of FIG. 2, many variations and alternatives are possible.

In an embodiment, a first portion of an authentication technique includes recording measurements of a VT TEE (MemCore) in a TPM and sealing a secret K to the current state of the TPM. This part is done leveraging secure and measured boot protections and extending measurements of MemCore to a TPM PCR. A secret K is generated and is sealed to the current PCR state when MemCore is launched, ensuring that the secret K can only be extracted by the same entity (MemCore) at a time in the boot process when the platform and the PCRs are in the same state.

Next, an environment can be created to obtain quotes from MemCore and a target SGX enclave. In an embodiment, this isolated environment includes a target enclave, quoting enclave, target application (non-enclave portion of the target enclave) and a MemCore driver. This entire environment may be launched using MemCore protections, ensuring that an unauthorized party outside of this trusted computing base (TCB) cannot intercept or insert or affect any communication between these trusted parties. The target application obtains measurement quote of the MemCore environment that includes the sealed secret K. This quote contains information about the boot chain through the signed TPM values and TCG logs, allowing a knowledgeable third party to evaluate this information and make assertions on the boot chain of the platform. Additionally, the target application obtains a measurement quote from the target enclave regarding the SGX measurements associated with the platform. An SGX-based application (enclave) can attest itself to a backend server. The target application combines both quotes (from the TPM and SGX) in a single blob and sends it to the backend attestation server in a single secure socket layer (SSL) session.

After a backend attestation of the quotes, the shared secret K may be distributed. Thus if the backend server can verify the two TEEs properly, it sends back a successful response that includes the shared secret K to both the enclave and the MemCore. The two TEEs evaluate the successful response from the server and then use the shared secret for future communication. An additional challenge nonce from the backend attestation server may be included as part of the exchange to prove liveliness.

Through this entire binding process MemCore protections ensure that the enclaves being bound are within the MemCore TEE trust boundary. This initial binding is a one-time process that may be avoided during future reboots, unless some core components of the system environment is changed. As such, future operations do not implement a lengthy initialization process, and instead trusted environments establish trust with each other through the shared secret K.

As such, embodiments provide techniques for bidirectional authentication of a VT EPT-based TEE (MemCore-based) and an SGX enclave without instruction set architecture extensions, using MemCore protections on the enclave during the initial binding process and use this protection to communicate secrets between these parties.

At a high level, attestation may be performed as part of an OS installation. In an embodiment, an end user can download and install an SGX/MemCore protected environment. In turn, an application installer notes that a MemCore installation is missing and starts the installation process. If the SGX installation is missing, it is installed first. Then all architectural enclaves are established. Communication with the SGX backend attestation serve also may be verified. Thereafter MemCore elements are installed, with the goal of establishing a common secret “K” between SGX and MemCore. On a Windows™-based platform, this MemCore can be installed as part of Microsoft™ early launch anti-malware (ELAM) code, allowing early, measured boot within a boot chain. Next an AIK provisioning process is undertaken with the TPM and backend server. The AIK is used in the future to obtain TPM measurement quotes. Note that MemCore installation may include an underlying trusted memory services layer environment in the VMM which manages EPT-based memory views (page tables) and an associated, self-protecting ring-0 agent. If a VMM such as a Windows™ Hyper-V exists in the current environment, the MemCore VMM can be installed as a nested VMM on top of Hyper-V™. If a root VMM is not present, the MemCore VMM is installed as the root VMM. Thereafter, the signed MemCore driver and target application are installed. At this point, a reboot is requested which results in rebooting the new environment using secure/measured boot.

Next, measurements of MemCore can be made into a TPM. In one embodiment, as part of a secure/measured boot platform, firmware and OS measurements are extended to PCRs 0 to 14. The ELAM driver measurements are extended to PCR 15. In turn, the ELAM driver launches the ELAM-signed MemCore environment and extends the measurements to PCR 15. A secret K is generated that is sealed to the current PCR[0 . . . 15] state. Thereafter, an invalid or dummy measurement is extended to PCR15 to poison the current PCR15 state, ensuring no other party is able to extract or modify K.

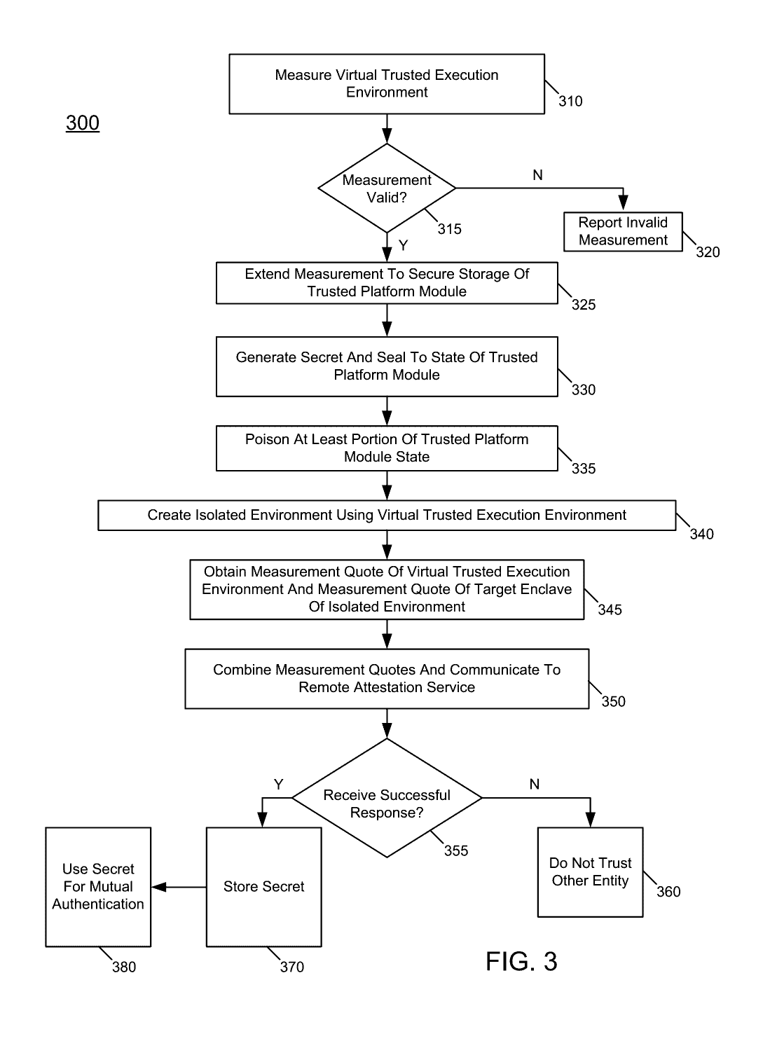

Referring now to FIG. 3, shown is a flow diagram of a method for preparatory operations to be performed in creating a secure environment as described herein. As seen in FIG. 3, method 300 may begin by measuring the virtual TEE, as discussed above (block 310). Next it is determined at diamond 315 if the measurement is valid. If not, control passes to block 320 where an invalid measurement may be reported, e.g., to a user of the computing system, a management entity associated with a computing system, a remote attestation service or one or more other destinations (or a combination of these).

Still with reference to FIG. 3, if instead the measurement is valid, control passes to block 325 where the measurement can be extended to a secure storage of the trusted platform module, e.g., to one or more PCRs of the TPM (block 325). Thereafter at block 330 a secret can be generated and sealed to the secure state of the TPM (block 330). In the case of a CSE security coprocessor, the coprocessor has dedicated flash memory (SRAM) that is secured storage. The TPM also has a dedicated non-volatile flash memory.

Next at block 335 at least a portion of the TPM state may be poisoned. In this way, unauthorized entities cannot successfully use the secret sealed to the prior TPM state. In an embodiment, an invalid or dummy measurement value may be extended to at least one PCR of the TPM to thereby poison the TPM state. Still with reference to FIG. 3, next control passes to block 340 where an isolated environment can be created. More specifically as discussed above the virtual TEE may create this isolated environment which can include different entities in a given embodiment.

Next at block 345 a measurement quote of the virtual TEE and a measurement quote of a target enclave (e.g., a given secure enclave of the isolated environment) can be obtained. In an embodiment, these measurement quotes may be obtained responsive to a request from a ring-3 application executing within the isolated environment. At block 350, these measurement quotes may be combined, with the combined measurement information to be communicated to a given attestation service, e.g., a remote attestation service. Thereafter at diamond 355 it is determined whether a successful response is received. If so, the secret is stored (block 370). More specifically, this secret may be securely stored in various storage locations accessible both to the target enclave and the virtual TEE. As such (as shown at block 380), these entities may later use such secret to perform a mutual authentication, such as when these entities are to interact during system operation. If instead a successful report is not received, control instead passes to block 360 where the entities may be configured such that they do not trust the other entity such as by placement of the given other entity on a blacklist of untrusted entities. As such, depending on a particular security policy, interaction with the other entity may be prohibited.

Next, an example flow for creating a protected environment that can obtain quotes securely from MemCore and enclaves is described. Here, a new environment as in FIG. 1 is launched that includes a target enclave, a quoting enclave, a target application and a MemCore driver. These components' execution (code/data) and dynamic memory can be protected by a single MemCore view such that the target application data region can only be written to by one of the trusted components. The target application requests a TPM measurement quote from MemCore with the sealed secret. The target application requests a measurement quote from the target enclave. When the quotes arrive, the target application is assured that quotes came from only the requested entities as no other entity was allowed to write its memory region by dint of the MemCore view. Optionally, these quotes may be requested using a liveliness nonce received from an external attestation/verifying server. The target application combines the two quotes into a single blob.

Next, an example remote attestation is described. Here, a backend attestation service can verify the quotes and distribute the shared secret. The target application creates an SSL session with the backend attestation/verifying server. This step may be completed earlier, if a liveliness nonce is included as part of the measurement quotes. The backend attestation server verifies the two quotes and provides a successful response to the enclave and the MemCore environment. The response also includes the shared secret K. The response is distributed to the target enclave. After verifying the response, the target enclave now also has the shared secret K. The enclave may encrypt the shared secret K using an enclave-specific encryption key and store it in a location that can be accessed in future communications. The response is also distributed to the MemCore driver, which now has confirmation that the SGX-to-MemCore binding protocol is complete. K may be sealed to MemCore and the TPM state, allowing this to be retrieved in future boots. Both environments can now proceed to using the shared secret K in future communication. In a future operation that involves a reboot, the shared secret K is only available to a properly validated MemCore environment. Embodiments thus establish a shared secret K between MemCore VMM and the enclave to be used for future boots without interaction with a backend verifying server.

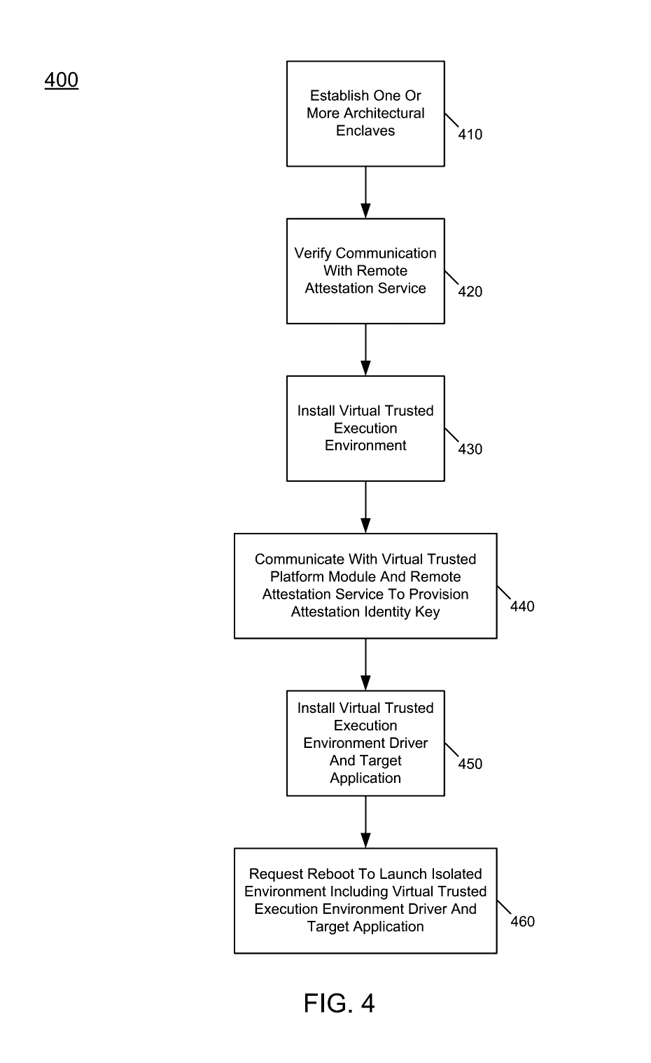

Referring now to FIG. 4, shown is a flow diagram of a method for performing further preparatory operations, e.g., with regard to creation and initialization of an isolated environment. As seen, method 400 begins by establishing one or more architectural enclaves (block 410). Such architectural enclaves may be independent and isolated memory regions that enable secure operations to be performed. Next at block 420, communication can be verified with a remote source, e.g., a remote authentication service. In an embodiment, this communication link may be established according to a secure SSL connection. Thereafter at block 430, the virtual TEE may be installed. As discussed above, this virtual TEE may be a VMM, hypervisor or other control entity to control one or more virtualized environments executing thereunder.

Next at block 440, communication may be performed with a trusted platform module and a remote attestation service to provision an attestation identity key (AIK). Thereafter, at block 450, a virtual TEE driver and a target application may be installed within the isolated environment. As one such example, the target application may be an authentication application provided by a remote attestation service to enable secure user authentications to the computing system. Finally at block 460 the computing system can be rebooted responsive to a reboot request. In this way, the isolated environment can be launched that includes this target application and driver. Understand while shown at this high level in the embodiment of FIG. 4, many variations and alternatives are possible.

Isolated environments as described herein can be used in many different contexts. For purposes of discussion, one such use is to enable interaction between separate isolated environments, namely the isolated environment and a virtual TEE via a mutual authentication process such that thereafter the two entities can trust each other to perform desired operations.

One example application is the use of VT (MemCore)-based trusted I/O and sensor protection for SGX. Such protection can be information to enable relying parties, like banks to use for assessing confidence about a given platform's data (e.g., biometric or keyboard data for authentication purpose). Such capabilities may be used for a YAP authentication service. In the trusted-I/O solution, driver sensitive data transfer protection is accomplished using MemCore and driver sensitive data processing protection using SGX. As an example, iris scan data protection from a biometric sensor communicated to a SGX memory data buffer protection can be done in MemCore. The SGX enclave can then protect data processing to generate an iris scan template and future match results. It can also communicate to a YAP backend server.

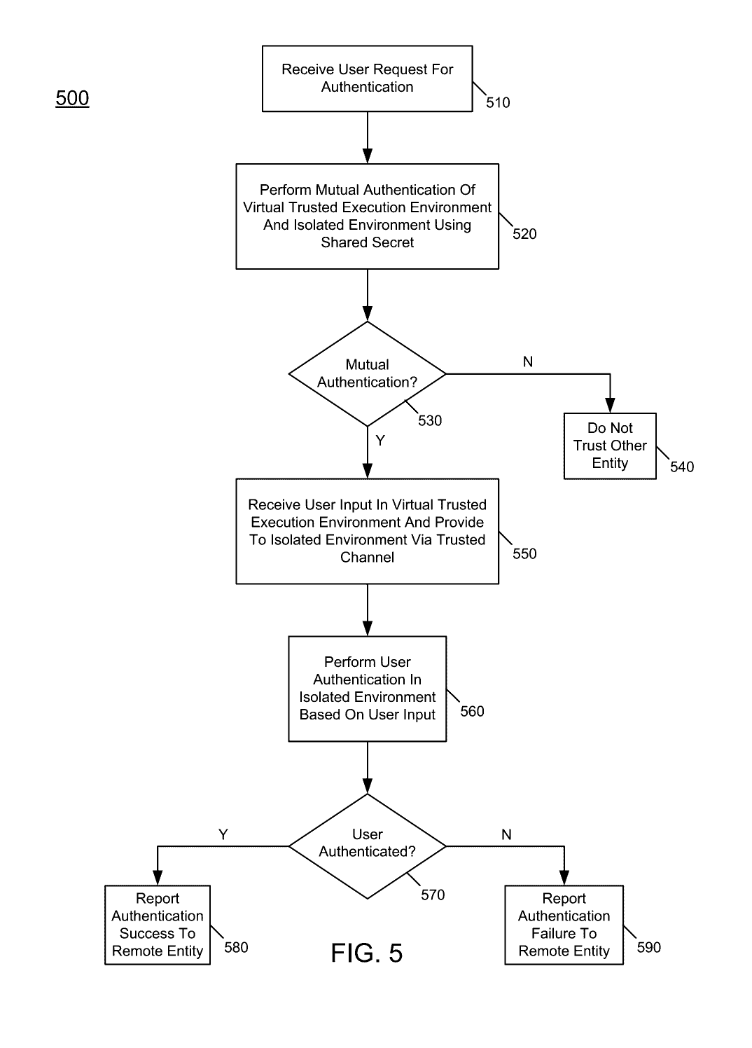

Referring now to FIG. 5, shown is a flow diagram of an example method for performing a mutual authentication between isolated environments. As seen, method 500 begins by receiving a user request for an authentication (block 510). Understand that such request can be received from a user seeking to access secure information, either already present within the computing system or accessible via a remote location such as in the process of performing a financial transaction. Assume a user has an account with a financial institution or the user seeks to execute a commercial transaction where the user is to provide secure payment information, e.g., in the form of credit card information, bank account information or other such information of a financial or other secure or sensitive nature. Control next passes to block 520 where a mutual authentication of the virtual TEE and an isolated environment can occur. More specifically, such mutual authentication can occur using the previously stored shared secret.

Next as a result of this mutual authentication process, it can be determined whether the environments mutually authenticate to each other (diamond 530). If not, control passes to block 540 where the two entities do not trust each other. As such, it is possible that further operations for the user authentication or access to requested information may be prevented.

Otherwise if a successful authentication occurs, control passes to block 550 where user input can be received. More specifically, this user input may be received in the virtual TEE and provided to the isolated environment. For example, the user input may be input of user information via a keyboard such as a username, password or other information. In other cases or in combination, one or more biometric sources of information may be provided by way of the virtual TEE. Note that such communication between the virtual TEE and the isolated environment may occur via a trusted channel. As such, this secure path cannot be snooped by any other entity. Thereafter at block 560 user authentication can occur in the isolated environment using this information. For example, the application itself may be configured to perform the user authentication locally. Or the application may communicate with a backend remote attestation service to perform this user authentication. If it is determined that the user is authenticated at diamond 570, control passes to block 580 where the authentication success can be reported, e.g., to a remote entity (e.g., a website with which the user is seeking to perform a transaction). If however the user authentication is not successful, control passes to block 590 where failure can be reported.

In various embodiments, it is possible to provide enhanced protection for secure content available to the computing device when the computing device takes on a rooted status. Such rooted status means that the device has entered into a control environment with superuser privilege capabilities such that a user having access in this rooted status mode can perform a variety of sensitive operations. Such operations could include activities that compromise the security of secure content such as digital rights management (DRM) content and/or enterprise rights management (ERM) content. Accordingly, embodiments may provide an ability to apply one or more security policy measures to prevent improper access or use of secure content when a rooted status is detected.

Embodiments may also be used to protect secure content when a device becomes rooted. Using an embodiment, offline/downloaded content(s) is provisioned and managed in a trusted storage environment (TSE). The TSE can be instantiated using several techniques including: a system management mode (SMM) handler; a SGX enclave for a storage drive; a virtualization engine (VE) IP block with partitioned OPAL drives; and a memory partition unit (MPU). The TSE is accessible by both platform TEE (e.g., a SGX enclave or converged security manageability engine (CSME)) and a host processor.

A host SGX enclave/SMM-based virtualization engine uses a storage channel exposed by TSE running on the VE for storing and managing content on the VE-exposed file system, thereby avoiding significant performance overhead. The host SGX enclave/SMM-based virtualization engine uses the control channel exposed by an architectural enclave to communicate with the platform CSME to store DRM license/keys. In this way, a platform CSME or SGX enclave VE can selectively and securely perform content and associated license/keys removal on detecting a platform to be in rooted status. Additionally, the platform TEE has the capability to monitor and take policy based actions on the attempt to retrieve/play content post-license rejection due to rooting. Using an embodiment, a TSE exposed by a VE for virtual or physical partitions is secure and scalable for devices from Internet of Things (IOT) devices, wearables to tablets/PCs.

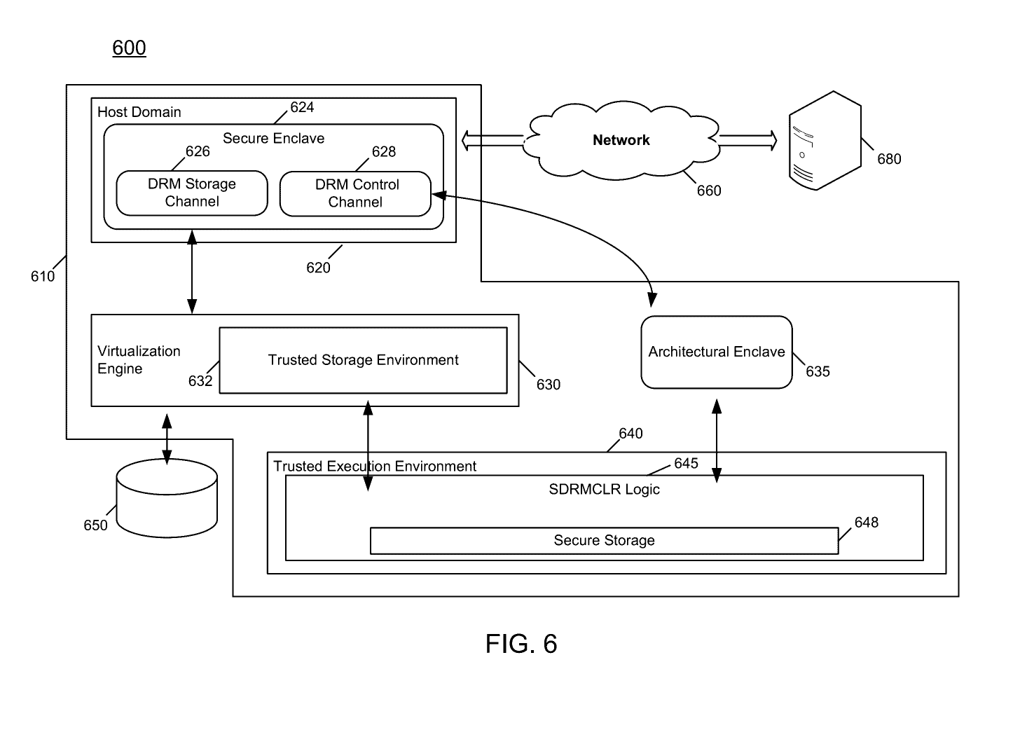

Referring now to FIG. 6, shown is a block diagram of a computing environment in accordance with another embodiment of the present invention. As shown in FIG. 6, environment 600 may be any type of network-based computing environment. In the embodiment shown, computing environment 600 includes a processor 610 which may be of any type of network-based computing device that may couple, e.g., via a network 660, to a remote content provider 680. In various embodiments, content provider 680 may be a cloud-based DRM content and license provider. As examples, the content provider may be a video content provider such as Netflix™, Hulu™, or any other remote content provider that makes secure content available pursuant to a subscription or other model. In many cases, this secure content may be protected by one or more of content keys and/or content licenses, which may be provided with such content via network 660.

As illustrated in FIG. 6, processor 610 may be a general-purpose processor such as a multicore processor and/or a system-on-chip. In the embodiment shown, processor 610 includes a host domain 620, which may be a host domain of the processor. Such host domain may be implemented using one or more cores of the processor. In the embodiment shown, host domain 620 includes a secure enclave 624 that may be implemented via a protected and isolated memory partition and may include a DRM storage channel 626 and a DRM control channel 628.

As illustrated, DRM storage channel 626 may be in communication with a virtualization engine (VE) 630. Embodiments of a VE may include an IP block of a SoC that virtualizes the storage controller. MemCore with storage controller virtualization may be another embodiment. VE 630 is a tamper resistant hardware IP block that can provide a virtualized disk (VD) as a shared file system between host processor and a TEE. In the embodiment shown, virtualization engine 630 includes a Trusted Storage Environment (TSE) 632. Trusted storage environment 632 may be implemented as a shared file system between host domain 620 and a TEE 640. Note that TEE 640 that has tamper resistant isolated execution and storage environment independent of host CPU. Note that this trusted storage environment may provide for storage in a storage 650 which may be any type of storage, including a disk drive, flash memory, multi-level memory structure or so forth.

Still with reference to FIG. 6, TEE 640 includes a logic 645. Note that TEE 640 may be a second or third TEE implemented as an IP block of a SoC, which is a secure microcontroller or co-processor. The methods described above for TEE-TEE secure session key establishment with attestation may be applied to block 640 in conjunction with any of the other TEE environments described. In one example, logic 645 may be a secure DRM clear (SDRCLR) logic 645. Such logic may be adapted to detect a rooting of system 600 and perform one or more enforcement mechanisms with regard to secure content according to one or more security policies. As further illustrated, TEE 640 includes a secure storage 648. In various embodiments, secure storage 648 may securely store content licenses and/or keys associated with secure content.

As seen, communication between host domain 620 and TEE 640 may be by way of an architectural enclave 635. Detection of rooted platforms can be achieved using trusted/secure boot processes as defined by the TCG and UEFI forum. Embodiments link DRM content key access to integrity register values for a non-rooted OS image. Nevertheless, detection does not guarantee removal of DRM content. As such, a TEE takes further action to notify the TSE to remove DRM contents from memory or take other actions pursuant to a security policy. Understand while shown in this particular system implementation in the embodiment of FIG. 6, many variations and alternatives are possible.

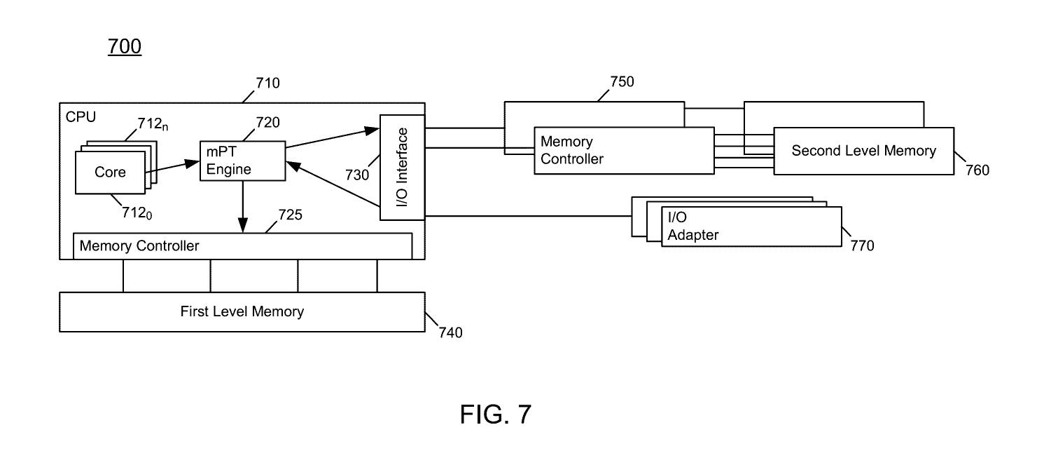

Understand that the secure content policy enforcement can be performed in a variety of different system configurations. Referring now to FIG. 7, shown is a block diagram of another system in accordance with an embodiment. In the implementation shown in FIG. 7 is a system having a multiple-level arrangement, including a closer, local memory 740 and a more distant, but larger second level memory 760. As shown in FIG. 7, system 700 is a given computing system and includes a central processing unit (CPU) 710. As illustrated, CPU 710 is a multicore processor including a plurality of cores 712₀-712ₙ. In turn, cores 712 communicate with a memory protection engine (mPT) 720 that in turn interfaces with an IO interface 730 and an internal memory controller 725. As seen, internal memory controller 725 may interact with first memory 740, which may be implemented as a first level memory that acts as a hardware managed, software transparent memory side cache. In different embodiments, first level memory 740 may be implemented as a dynamic random access memory (DRAM). As further illustrated, communication also may occur with a second level memory 760 which may be a more remote, more capacious persistent memory. As seen, an external memory controller 750 may interface between CPU 710 and second level memory 760. As further illustrated, IO interface 730 may also adapt with one or more IO adapters 770.

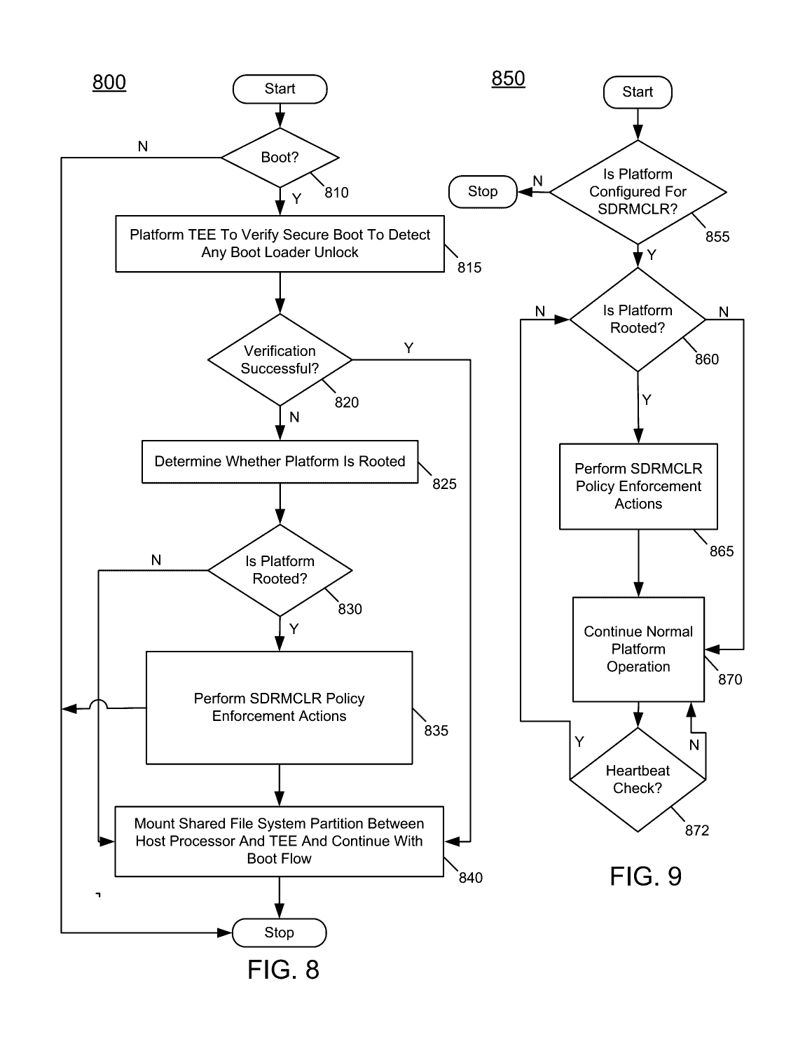

Referring now to FIG. 8, shown is a flow diagram of a method for performing a secure content clear operation during a boot environment of a system. As shown in FIG. 8, method 800 may be performed by various combinations of hardware, software, and/or firmware of a system during a boot up of a system. Thus assuming that it is determined that a boot is occurring (at diamond 810) control passes to block 815 where a platform TEE may be used to verify a secure boot and to detect whether any boot loader unlock has occurred. Next it is determined whether the verification is successful (namely that a secure boot is underway and no unlock is detected). If so, control passes directly to block 840 where a shared file system partition may be mounted between a host processor (e.g., a host domain) and the TEE. Thereafter, continued boot flow operations may occur.

If instead the verification is not determined to be successful, control passes from diamond 820 to block 825 where it is determined whether the platform is rooted. In different embodiments, a TEE may detect platform rooting in different ways. In any event, it is next determined at diamond 830 if the platform is rooted. If not, control passes to block 840 discussed above. Otherwise if a rooted platform is present, control passes to block 835 where a secure DRM clear operation may be initiated to perform security policy enforcement actions. Note that different such actions are possible according to particular security policies. As examples, such actions may include destroying of licensed content and/or associated licenses and/or keys. Alternately, an OS boot may be prevented. And/or in addition to such actions, a user/OEM may be alerted of the rooted condition. After such operations are performed, control thereafter passes to block 840.

Referring now to FIG. 9, shown is a flow diagram of a method for performing a secure content, clear operation during a boot environment of a system. As shown in FIG. 9, method 850 may be performed by various combinations of hardware, software, and/or firmware of a system during a runtime of a system. As seen, method 850 begins by determining whether the platform is configured for secure DRM clear operations (diamond 855). If so, control next passes to diamond 860 to determine whether the platform is rooted. If not, control passes to block 870 where normal platform operation may continue. Note that during such operation, a heartbeat check may be routinely made (diamond 872). As part of such heartbeat checking it can be determined whether the platform is rooted (as above at diamond 860).

Otherwise if it is determined at diamond 860 that the platform is rooted, control passes to block 865, where a given secure DRM clear policy enforcement action may be taken, as discussed above. Thereafter, control passes to block 870, where normal platform operations may continue. Understand while shown at this high level in the embodiment of FIG. 9, many variations and alternatives are possible.

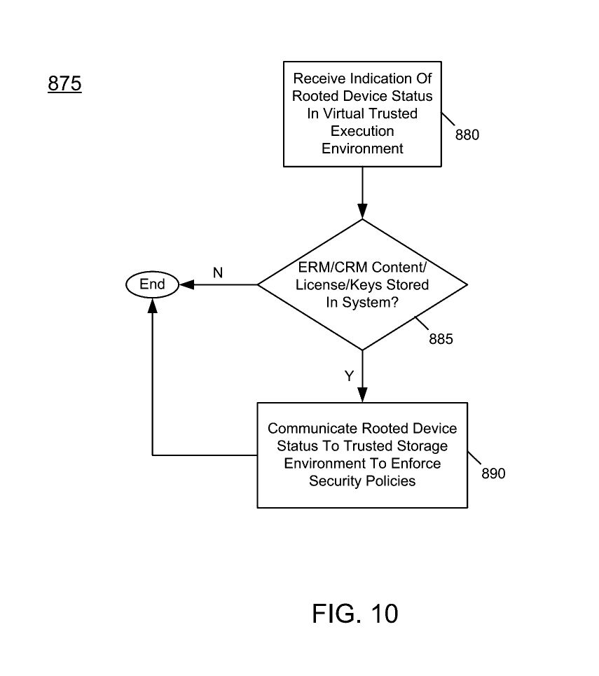

Referring now to FIG. 10, shown is a flow diagram of a method for performing secure content clear operations in accordance with another embodiment. More specifically in FIG. 10, method 875 may be used to perform a secure clear operation in an environment as in FIG. 1, namely with multiple separate isolated environments such as a MemCore isolated environment that executes under a virtual TEE. As seen, method 870 begins at block 880 where an indication of a rooted device status may be received in the virtual TEE. Note that this rooted device status may be received from a given entity such as a secure boot applet running within the virtual TEE (e.g., MemCore VMM of FIG. 1). Note also that in another embodiment, a MemCore TEE may detect rooting of an OS or peer TEE. A peer TEE may also detect rooting of another peer TEE. Next at diamond 885 it can be determined whether there is trusted content, licenses, and/or keys stored in the system. More specifically, it can be determined whether in a trusted storage environment there exists secure content protected by a set of corresponding licenses and/or keys such as may be stored in a secure storage of a TEE. If it is determined that such information is stored in the system (which may have been obtained and stored prior to the system being rooted), control passes to block 890 where this rooted device status may be communicated to the trusted storage environment. In turn, this trusted storage environment (which may be implemented at least in part by an isolated environment as described herein) can enforce various security policies, which, as discussed above may include removal of such content licenses and/or keys, a revoking of one or more licenses, prevention of access to such information while the system remains in the rooted device state or so forth. Understand while shown at this high level, many variations and alternatives are possible.

Embodiments may further securely remove or otherwise protect selective content associated with a particular DRM/ERM scheme mandated by a specific content provider. For example, embodiments may remove content and licenses associated only with NetFlix™ or Hulu™, or both. Embodiments may also log and securely communicate attempts to play content on a rooted device, e.g., to one or more selected content providers, via a usage metering capability. Still further, embodiments may selectively scramble content and associated licenses using the TSE and TEE, upon rooted status detection.

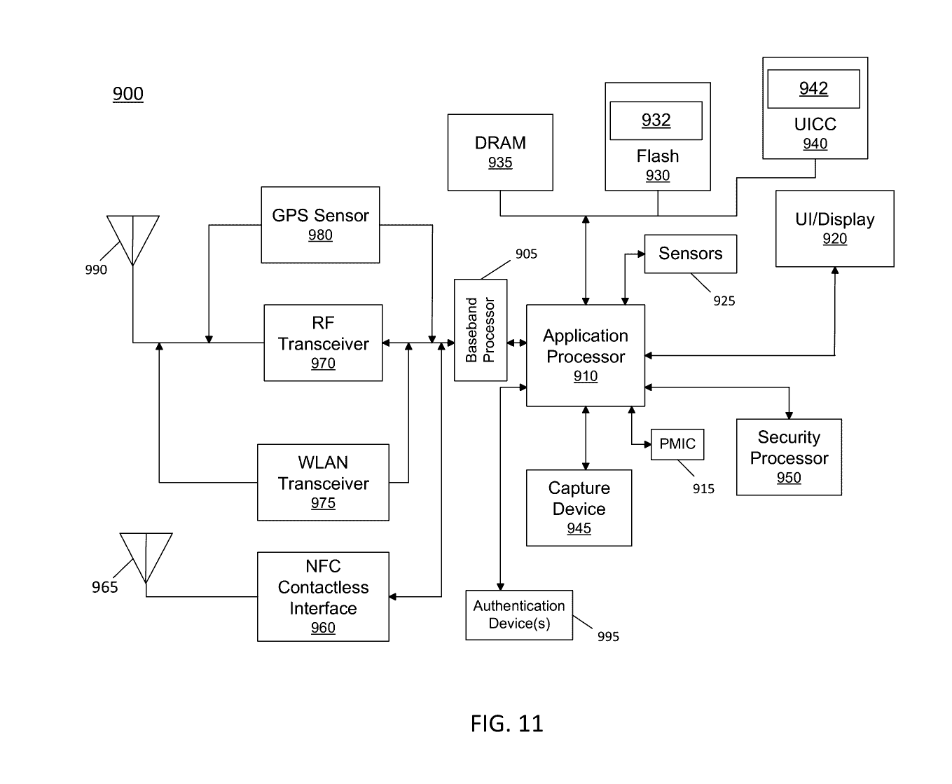

Referring now to FIG. 11, shown is a block diagram of an example system with which embodiments can be used. As seen, system 900 may be a smartphone or other wireless communicator, on which secure content can be stored. A baseband processor 905 is configured to perform various signal processing with regard to communication signals to be transmitted from or received by the system. In turn, baseband processor 905 is coupled to an application processor 910, which may be a main CPU of the system to execute an OS and other system software, in addition to user applications such as many well-known social media and multimedia apps. Application processor 910 may further be configured to perform a variety of other computing operations for the device. Application processor 910 may be configured with one or more trusted execution environments to perform embodiments described herein.

Application processor 910 can couple to a user interface/display 920, e.g., a touch screen display. In addition, application processor 910 may couple to a memory system including a non-volatile memory, namely a flash memory 930 and a system memory, namely a DRAM 935. In some embodiments, flash memory 930 may include a secure portion 932 in which sensitive information (including downloaded content subject to restrictions set forth in one or more content licenses) may be stored. As further seen, application processor 910 also couples to a capture device 945 such as one or more image capture devices that can record video and/or still images.

Still referring to FIG. 11, a universal integrated circuit card (UICC) 940 comprising a subscriber identity module, which in some embodiments includes a secure storage 942 to store secure user information. System 900 may further include a security processor 950 that may couple to application processor 910. In various embodiments, at least portions of the one or more trusted execution environments and their use may be realized via security processor 950. A plurality of sensors 925 may couple to application processor 910 to enable input of a variety of sensed information such as accelerometer and other environmental information. In addition, one or more authentication devices 995 may be used to receive, e.g., user biometric input for use in authentication operations.

As further illustrated, a near field communication (NFC) contactless interface 960 is provided that communicates in a NFC near field via an NFC antenna 965. While separate antennae are shown in FIG. 11, understand that in some implementations one antenna or a different set of antennae may be provided to enable various wireless functionality.

A power management integrated circuit (PMIC) 915 couples to application processor 910 to perform platform level power management. To this end, PMIC 915 may issue power management requests to application processor 910 to enter certain low power states as desired. Furthermore, based on platform constraints, PMIC 915 may also control the power level of other components of system 900.

To enable communications to be transmitted and received, various circuitry may be coupled between baseband processor 905 and an antenna 990. Specifically, a radio frequency (RF) transceiver 970 and a wireless local area network (WLAN) transceiver 975 may be present. In general, RF transceiver 970 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 980 may be present, with location information being provided to security processor 950 for use as described herein. Other wireless communications such as receipt or transmission of radio signals, e.g., AM/FM and other signals may also be provided. In addition, via WLAN transceiver 975, local wireless communications, such as according to a Bluetooth™ or IEEE 802.11 standard can also be realized.

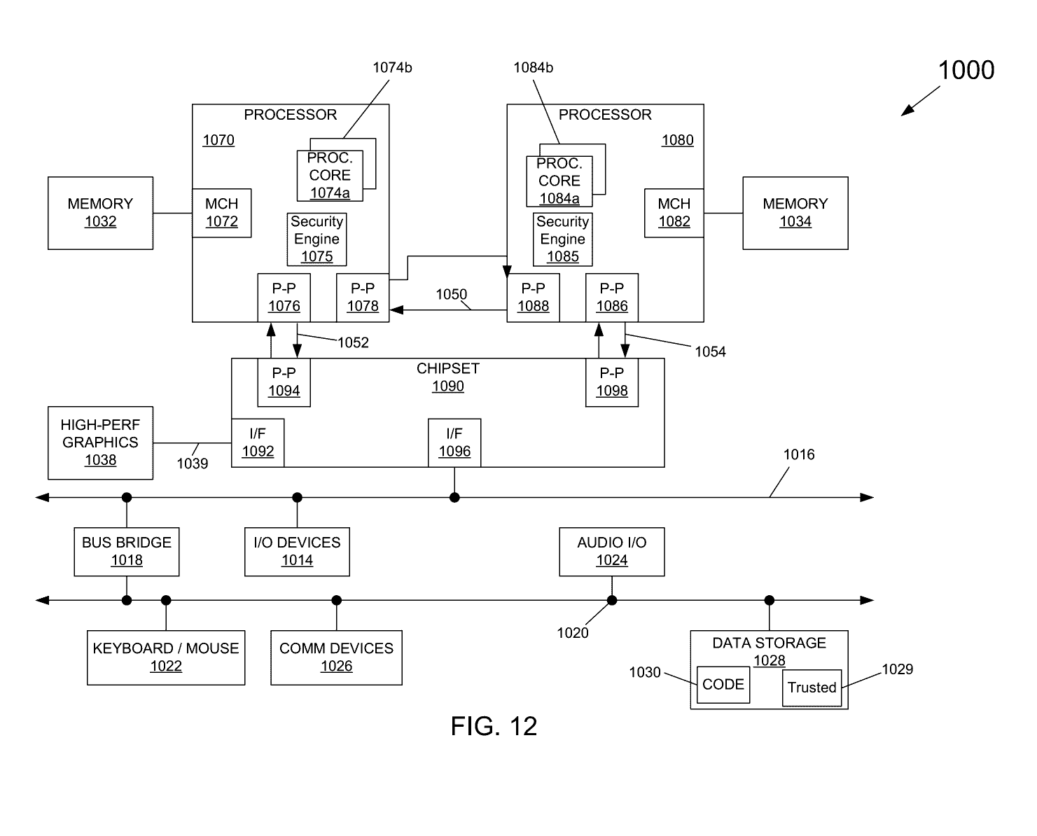

Referring now to FIG. 12, shown is a block diagram of a system in accordance with another embodiment of the present invention. As shown in FIG. 12, multiprocessor system 1000 is a point-to-point interconnect system, and includes a first processor 1070 and a second processor 1080 coupled via a point-to-point interconnect 1050. As shown in FIG. 12, each of processors 1070 and 1080 may be multicore processors such as SoCs, including first and second processor cores (i.e., processor cores 1074a and 1074b and processor cores 1084a and 1084b), although potentially many more cores may be present in the processors. In addition, processors 1070 and 1080 each may include a security engine 1075 and 1085 to create a TEE and to perform at least portions of the content management and other security operations described herein.

Still referring to FIG. 12, first processor 1070 further includes a memory controller hub (MCH) 1072 and point-to-point (P-P) interfaces 1076 and 1078. Similarly, second processor 1080 includes a MCH 1082 and P-P interfaces 1086 and 1088. As shown in FIG. 11, MCH's 1072 and 1082 couple the processors to respective memories, namely a memory 1032 and a memory 1034, which may be portions of main memory (e.g., a DRAM) locally attached to the respective processors. First processor 1070 and second processor 1080 may be coupled to a chipset 1090 via P-P interconnects 1052 and 1054, respectively. As shown in FIG. 11, chipset 1090 includes P-P interfaces 1094 and 1098.

Furthermore, chipset 1090 includes an interface 1092 to couple chipset 1090 with a high performance graphics engine 1038, by a P-P interconnect 1039. In turn, chipset 1090 may be coupled to a first bus 1016 via an interface 1096. As shown in FIG. 12, various input/output (I/O) devices 1014 may be coupled to first bus 1016, along with a bus bridge 1018 which couples first bus 1016 to a second bus 1020. Various devices may be coupled to second bus 1020 including, for example, a keyboard/mouse 1022, communication devices 1026 and a data storage unit 1028 such as a non-volatile storage or other mass storage device which may include code 1030, in one embodiment. As further seen, data storage unit 1028 also includes a trusted storage 1029 to store, among other information, downloaded content subject to restrictions of one or more content licenses. Further, an audio I/O 1024 may be coupled to second bus 1020.

In Example 1, a method comprises: recording at least one measurement of a virtual trusted execution environment in a storage of a trusted platform module of the system and generating a secret sealed to a state of the trusted platform module; creating, using the virtual trusted execution environment, an isolated environment, the isolated environment including a secure enclave, an application, and a driver, the driver to interface with the virtual trusted execution environment, the virtual trusted execution environment to protect the isolated environment; receiving, in the application, a first measurement quote associated with the virtual trusted execution environment and a second measurement quote associated with the secure enclave; and communicating quote information regarding the first and second measurement quotes to a remote attestation service to enable the remote attestation service to verify the virtual trusted execution environment and the secure enclave, where responsive to the verification the secret is to be provided to the virtual trusted execution environment and the isolated environment.

In Example 2, the method of Example 1 further comprises recording the at least one measurement by extension of a plurality of PCRs of the trusted platform module.

In Example 3, the method of one or more of the above Examples further comprises measuring boot code, firmware, and an operating system, and recording the measurement by extension of at least some of the plurality of PCRs of the trusted platform module.

In Example 4, the method of one or more of the above Examples further comprises extending a measurement of an anti-malware agent to a first PCR of the plurality of PCRs of the trusted platform module, executing the anti-malware agent to create the isolated environment, and extending the measurement of the isolated environment to the first PCR.

In Example 5, the method of one or more of the above Examples further comprises extending an invalid measurement to the first PCR to poison a state of the first PCR.

In Example 6, the method of Example 5 further comprises generating the secret sealed to the state of the trusted platform module prior to extension of the invalid measurement, to prevent unauthorized access to the secret.

In Example 7, the application is to combine first information of the first measurement quote and second information of the second measurement quote to generate the quote information for communication to the remote attestation service.

In Example 8, the method of Example 7 further comprises receiving a response from the remote attestation service regarding a successful authentication.

In Example 9, the method of Example 8 further comprises, responsive to the response, distributing the secret to the secure enclave and a driver of the isolated environment.

In Example 10, the driver and the secure enclave are to perform a mutual attestation using the secret, and thereafter to enable data to be communicated between the driver and the secure enclave.

In another example, a computer readable medium including instructions is to perform the method of any of the above Examples.

In another example, a computer readable medium including data is to be used by at least one machine to fabricate at least one integrated circuit to perform the method of any one of the above Examples.

In another example, an apparatus comprises means for performing the method of any one of the above Examples.

In Example 11, a system comprises: a processor including: a host domain having at least one core and a first security agent to provide a trusted storage channel and a trusted control channel; a trusted execution agent including a first storage to store a first content license associated with first content, the trusted execution agent including a first logic to detect if the system is rooted and if so, to enforce one or more security policies associated with the first content; and a virtualization engine to provide a trusted storage environment having a shared file system between the host domain and the trusted execution agent; and a storage coupled to the processor to store the first content protected by the first content license, where the storage is to maintain the trusted storage environment.

In Example 12, the trusted storage channel is to communicate with the trusted storage environment and the trusted control channel is to communicate with an architectural enclave, where the architectural enclave is to communicate with the trusted execution environment.

In Example 13, the virtualization engine is to create a virtual disk comprising the trusted storage environment.

In Example 14, the storage of the system of one or more of the above Examples comprises a first level memory and a second level memory, where the processor comprises a memory controller to communicate with the first level memory, the first level memory comprising a memory side cache, the memory side cache transparent to software and managed by the memory controller.

In Example 15, the trusted storage environment of Example 14 is to store the first content in the second level memory and to store the first content license in the first level memory.

In Example 16, the trusted execution agent of Example 15 is to communicate a removal message to a memory protection engine of the processor, the memory protection engine to communicate the removal message to the second level memory to cause the second level memory to remove the first content.

In Example 17, the trusted execution agent of one or more of the above Examples is to enforce the one or more security policies by at least one of removal of the first content, prevention of loading of the first content and selectively scrambling the first content and the first content license.

In Example 18, the trusted execution agent of one or more of the above Examples is to log an attempt to play the first content when the system is rooted and to communicate information associated with the attempt to a first content provider associated with the first content.

In Example 19, the trusted execution agent of one or more of the above Examples comprises at least one of a converged security engine associated with an input/output adapter interface and a secure memory enclave having a plurality of protected partitions.

In Example 20, the first content was stored in the storage prior to the system being rooted, and the first content license is to indicate that the first content is to be removed if the system becomes rooted, the first content and the first content license associated with a first content provider, and where second content associated with a second content provider and stored in the storage is to be maintained in the storage after detection that the system is rooted.

In Example 21, the virtualization engine is to enable a plurality of instances of the trusted storage environment, including: a first trusted storage environment instance to execute on the host domain; a second trusted storage environment instance to execute on a manageability engine; and a third trusted storage environment instance to execute in a trusted virtualization mode of the host domain.

In Example 22, a method comprises: providing a system having a first trusted execution environment and a second trusted execution environment, each of the first and second trusted execution environments an isolated environment and mutually authenticated to each other based at least in part on a shared secret; receiving an indication in the first trusted execution environment that the system has been enabled for root access; and communicating a status of the root access to the second trusted execution environment to cause, responsive to root access status, the second execution environment to enforce a security policy associated with secure content stored in the system, the secure security policy enforcement including at least one of removal of the secure content and revocation of a license associated with the secure content.

In Example 23, the method further comprises providing a virtualized storage system via the second trusted execution environment, the virtualized storage system having a shared file system between the first trusted execution environment and the second trusted execution environment, the shared file system to store the secure content, and where the second trusted execution environment stores the license in a trusted storage separate from the shared file system.

In Example 24, a system comprises: means for providing a system having a first trusted execution environment and a second trusted execution environment, each of the first and second trusted execution environments an isolated environment and mutually authenticated to each other based at least in part on a shared secret; means for receiving an indication in the first trusted execution environment that the system has been enabled for root access; and means for communicating a status of the root access to the second trusted execution environment to cause, responsive to root access status, the second execution environment to enforce a security policy associated with secure content stored in the system, the security policy enforcement including at least one of removal of the secure content and revocation of a license associated with the secure content.

In Example 25, the system further comprises means for providing a virtualized storage system via the second trusted execution environment, the virtualized storage system having a shared file system between the first trusted execution environment and the second trusted execution environment, the shared file system to store the secure content, and where the second trusted execution environment stores the license in a trusted storage separate from the shared file system.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on a non-transitory storage medium having stored thereon instructions which can be used to program a system to perform the instructions. Embodiments also may be implemented in data and may be stored on a non-transitory storage medium, which if used by at least one machine, causes the at least one machine to fabricate at least one integrated circuit to perform one or more operations. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. At least one computer readable storage medium comprising instructions that when executed enable a system to:
record at least one measurement of a virtual trusted execution environment in a storage of a trusted platform module of the system and generate a secret sealed to a state of the trusted platform module;
create, using the virtual trusted execution environment, an isolated environment, the isolated environment including a secure enclave, an application, and a driver, the driver to interface with the virtual trusted execution environment, the virtual trusted execution environment to protect the isolated environment;
receive, in the application, a first measurement quote associated with the virtual trusted execution environment and a second measurement quote associated with the secure enclave; and
communicate quote information regarding the first and second measurement quotes to a remote attestation service to enable the remote attestation service to verify the virtual trusted execution environment and the secure enclave, wherein responsive to the verification the secret is to be provided to the virtual trusted execution environment and the isolated environment.

2. The at least one computer readable storage medium of claim 1, further comprising instructions that when executed enable the system to record the at least one measurement by extension of a plurality of platform configuration registers (PCRs) of the trusted platform module.

3. The at least one computer readable storage medium of claim 2, further comprising instructions that when executed enable the system to measure boot code, firmware, and an operating system, and record the measurement by extension of at least some of the plurality of PCRs of the trusted platform module.

4. The at least one computer readable storage medium of claim 2, further comprising instructions that when executed enable the system to extend a measurement of an anti-malware agent to a first PCR of the plurality of PCRs of the trusted platform module, execute the anti-malware agent to create the isolated environment, and extend the measurement of the isolated environment to the first PCR.

5. The at least one computer readable storage medium of claim 4, further comprising instructions that when executed enable the system to extend an invalid measurement to the first PCR to poison a state of the first PCR.

6. The at least one computer readable storage medium of claim 5, further comprising instructions that when executed enable the system to generate the secret sealed to the state of the trusted platform module prior to extension of the invalid measurement, to prevent unauthorized access to the secret.

7. The at least one computer readable storage medium of claim 1, wherein the application is to combine first information of the first measurement quote and second information of the second measurement quote to generate the quote information for communication to the remote attestation service.

8. The at least one computer readable storage medium of claim 7, further comprising instructions that when executed enable the system to receive a response from the remote attestation service regarding a successful authentication.

9. The at least one computer readable storage medium of claim 8, further comprising instructions that when executed enable the system to, responsive to the response, distribute the secret to the secure enclave and a driver of the isolated environment.

10. The at least one computer readable storage medium of claim 9, wherein the driver and the secure enclave are to perform a mutual attestation using the secret, and thereafter to enable data to be communicated between the driver and the secure enclave.

11. A system comprising:
a processor including:
a host domain having at least one core and a first security agent to provide a trusted storage channel and a trusted control channel;
a trusted execution agent including a first storage to store a first content license associated with first content, the trusted execution agent including a first logic to detect if the system is rooted and if so, to enforce one or more security policies associated with the first content; and
a virtualization engine to provide a trusted storage environment having a shared file system between the host domain and the trusted execution agent; and
a storage coupled to the processor to store the first content protected by the first content license, wherein the storage is to maintain the trusted storage environment.

12. The system of claim 11, wherein the trusted storage channel is to communicate with the trusted storage environment and the trusted control channel is to communicate with an architectural enclave, wherein the architectural enclave is to communicate with the trusted execution environment.

13. The system of claim 11, wherein the virtualization engine is to create a virtual disk comprising the trusted storage environment.

14. The system of claim 11, wherein the storage comprises a first level memory and a second level memory, wherein the processor comprises a memory controller to communicate with the first level memory, the first level memory comprising a memory side cache, the memory side cache transparent to software and managed by the memory controller.

15. The system of claim 14, wherein the trusted storage environment is to store the first content in the second level memory and to store the first content license in the first level memory.

16. The system of claim 15, wherein the trusted execution agent is to communicate a removal message to a memory protection engine of the processor, the memory protection engine to communicate the removal message to the second level memory to cause the second level memory to remove the first content.

17. The system of claim 11, wherein the trusted execution agent is to enforce the one or more security policies by at least one of removal of the first content, prevention of loading of the first content and selectively scrambling the first content and the first content license.

18. The system of claim 11, wherein the trusted execution agent is to log an attempt to play the first content when the system is rooted and to communicate information associated with the attempt to a first content provider associated with the first content.

19. The system of claim 11, wherein the trusted execution agent comprises at least one of a converged security engine associated with an input/output adapter interface and a secure memory enclave having a plurality of protected partitions.

20. The system of claim 11, wherein the first content was stored in the storage prior to the system being rooted, and the first content license is to indicate that the first content is to be removed if the system becomes rooted, the first content and the first content license associated with a first content provider, and wherein second content associated with a second content provider and stored in the storage is to be maintained in the storage after detection that the system is rooted.

21. The system of claim 11, wherein the virtualization engine is to enable a plurality of instances of the trusted storage environment, including:
a first trusted storage environment instance to execute on the host domain;
a second trusted storage environment instance to execute on a manageability engine; and
a third trusted storage environment instance to execute in a trusted virtualization mode of the host domain.

22. A method comprising:
providing a system having a first trusted execution environment and a second trusted execution environment, each of the first and second trusted execution environments an isolated environment and mutually authenticated to each other based at least in part on a shared secret;
receiving an indication in the first trusted execution environment that the system has been enabled for root access; and
communicating a status of the root access to the second trusted execution environment to cause, responsive to root access status, the second execution environment to enforce a security policy associated with secure content stored in the system, the security policy enforcement including at least one of removal of the secure content and revocation of a license associated with the secure content.

23. The method of claim 22, further comprising providing a virtualized storage system via the second trusted execution environment, the virtualized storage system having a shared file system between the first trusted execution environment and the second trusted execution environment, the shared file system to store the secure content, and wherein the second trusted execution environment stores the license in a trusted storage separate from the shared file system.
